(19) United States
(12) Patent Application Publication
(10) Pub. No.: US 2007/0281279 A1
(43) Pub. Date: Dec. 6, 2007

(54) Custom impression transfer coping

(76) Inventor: Viv Chander, Ottawa (CA)

Correspondence Address: PYLE & PIONTEK, 221 N. LASALLE - ROOM 2036, CHICAGO, IL, 60601, US

(21) Appl. No.: 11/447,375

(22) Filed: Jun. 6, 2006

(51) Int. Cl. A61C 8/00

(52) U.S. Cl. 433/173

(57) ABSTRACT

The present invention provides a hollow cylindrical custom impression transfer coping. Such hollow cylindrical custom impression transfer coping includes a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to be used. Such hollow cylindrical custom impression transfer coping further includes an injection port therein to enable the introduction into the volume within the hollow cylindrical custom impression transfer coping below the roof thereof, of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue.

### BACKGROUND OF THE INVENTION

1. Field of the Invention

This invention relates to a method for precisely capturing the custom markings of a healing abutment that is fitted to a dental implant. The present invention also provides a healing abutment for attachment to a dental implant with marking locations thereon, the marking locations being provided with markers that provide a binary code system for retrieving unique information about the healing abutment and the underlying implant. More particularly, the present invention is an improvement on the inventions patented in U.S. Patent No 6,558,162, patented May 6, 2003 and U.S. Pat. No. 6,790,040, patented Sep. 14, 2004.

2. Description of the Prior Art

One improvement which with the present invention is concerned involves the use of a conventional transfer coping. Transfer copings have an impression portion adapted to form a unique or indexed impression in the impression material and a base portion having mating indexing means adapted to mate with the exposed indexing means of the implant or prosthetic abutment. In use, the transfer coping is temporarily secured to the exposed proximal end of the implant fixture such that the mating indexing means of the impression coping and implant are mated in an interlocked manner to one another. Typically, a threaded screw or bolt is used temporarily to secure the transfer coping to the implant fixture.

Once the impression coping is secured to the implant fixture, an impression of the transfer coping relative to the surrounding teeth is taken. Typically, this involves a “U” shaped tray filled with an impression material that is placed in the patient's mouth over the implant site. Pressure is applied by hand on the tray, squeezing the impression material into the implant site and around the transfer coping. Within a few minutes, the impression material cures or hardens to a flexible, resilient consistency. The impression tray is then removed from the patient's mouth to reveal an impression of the implant site and the transfer coping. The restorative dentist then removes the transfer coping from the patient's mouth and transfers the transfer coping back into the impression material, being careful to preserve the proper orientation of the indexing means.

Another improvement which with the present invention is concerned relates to dental implants which are inserted or implanted into the jawbone of a patient at the site of missing natural teeth so that a denture or dental prosthesis can be fixed onto them. These implants usually consist of two parts, an endosseous part to be screwed into the jawbone and a built-up part or abutment which can be screwed into the endosseous part and which is usually conically designed on the end opposite the endosseous part. The denture, crown or prosthesis is fixed onto this tapered part. Such implants are well known in the art.

Restoration of an edentulous area of the mouth can be accomplished using a standard bridge, a removable appliance (a partial or full denture), or a dental implant. According to current conventional practice, the placement of the dental implant is usually accomplished in four stages.

In the first stage, the dentist reviews radiographs and dental models to determine the proper placement and axial alignment of the implant.

In the second stage, a dental surgeon accesses the bone through the mucosal (gum) tissue and drills or bores out the maxillary or mandibular bone. The implant is then screwed into the bone. A healing abutment, having a height at least equal to the thickness of the gingival (gum) tissue is typically placed over the implant, and the surrounding mucosal tissues are sutured around it. Complete osteointegration (an active bond between implant and tissue) typically takes anywhere from three to eight months.

In the third stage, following complete osteointegration, a healing abutment such as that described above, is removed, and an impression transfer coping is placed on the implant fixture. Once the impression transfer coping is secured, an impression is taken to record the axial position and orientation of the implant. An implant analog is secured to the implant impression transfer coping within the impression, and a model is fabricated in dental stone indicating precisely the placement and axial alignment of the implant in the bone relative to the hard and soft tissues of the oral cavity. The impression is used in order to properly to transfer the size and shape of adjacent teeth in relation to the permanently placed implant and the precise configuration and orientation of the implant to the stone model. The main objective of the impression is to provide the laboratory technician with a precise model of the mouth of the patient, including the orientation of the implant fixture relative to the surrounding teeth. Based on this model, the laboratory technician constructs the prosthetic abutment and a final restoration or prosthesis.

In the fourth stage, the restorative process involves removing the healing abutment from the implant fixture and placing the prosthetic abutment and final restoration or prosthesis.

The healing abutment which was typically placed over the implant and the surrounding mucosal tissues in the third stage generally included information markers thereon. The healing abutment was non-rotationally fastened to the implant with an abutment-attaching bolt. A common type of dental implant has a hexagonal or other shaped polygonal post or boss (commonly called a “hex”, which may also be a depression or “female”) on its gingival end that was adapted to mate with a cooperating socket on a restoration component. The information markers were located on at least one surface of the healing abutments to allow the dentist to determine the size of the healing abutment and the size and orientation of the implant seated below the healing abutment. The information markers, when used in combination, permitted identification of the healing abutment height, healing abutment diameter, dimensions of the attached implant seating surface, and implant hex orientation.

According to the prior art, and when used in the present specification, these information markers were characterized and disposed in many ways including the following:

on the top and/or the sides of the healing abutment;

extending outwardly (positive) from the healing abutment; extending inwardly (negative) towards the healing abutment; a combination of positive and negative information markers;

etching or otherwise defining the top or side surface of the healing abutment with a polygonal, numerical, or line marking to indicate height, location and orientation of the underlying hex, abutment and/or implant;

corresponding positive or negative information markers to the height of the abutment to be captured in an impression or subsequent scan;

several different types of information markers on the healing abutments to indicate and correspond to various characteristics of the implant and/or the healing abutment;

placing the information markers on the healing abutment in order to identify such characteristics as the diameter of the healing abutment, the diameter of the implant's seating surface (and, consequently, the size of the hex), the height of the healing abutment, and the orientation of the hex (and, thus, the angle of the underlying implant);

providing machined notches as information markers; enabling the quantity of notches and the location on the top and/or side surface of the healing implant to identify, for example, the height and diameter of the healing abutment; the placement of a numeral on the top or side surface of the healing implant as an information marker; the disposing of a bar code on the top or side surface of the healing abutment, the bar code being pre-coded with most of the dimensional variables of a particular healing abutment, whereby the bar code reader would display to obtain all of the required information about the healing abutment and the angular orientation of the implant hex by information markers on the top or side surface of the healing abutment;

the provision on the top and/or side surface of the healing abutment recessed dimples or raised pimples;

the provision of an etched or machined polygon (e.g., triangle, pentagon, hexagon, quadrilateral, etc.) to signify the location or existence of several of the healing abutment and/or implant variables;

the use of an etched or raised line on the top and/or side surfaces of the healing implant to allow indication of healing abutment or implant variable, the number and location of these lines indicating, for example, the height of the healing implant or the diameter of the implant or healing abutment; and the use of the different types of information markers, either alone or in combination, to aid in determining the different variables of the healing abutment and the implant.

The prior art teaches systems that utilize scanning technology to assist in generating a prosthesis. Such prior art scanning technology may be summarized as follows:

A scanning device can scan the region in the patient's mouth where the prosthesis is to be placed without the need to use impression materials or to construct a mold.

The impression material that is removed from the healing abutment and surrounding area is scanned to produce the permanent components.

A dentist can scan the stone model of the dental region that was formed from the impression material and mold.

The scanner may simply take the necessary information directly from the mouth of a patient without the need for impression material whatsoever. The information markers of the healing abutment provide the required information of the gingival aperture and the orientation of the underlying hexagonal boss on the implant. If a laser or photographic scanning system is used, the etched markers are identified just as easily as the markers that change the physical shape of the healing abutment.

Three basic scanning techniques exist, namely: laser scanning; photographic imaging; and mechanical sensing. Each scanning technique may be used or modified for any of the above-listed approaches (a scan of the stone model, a scan of the impression material, or a scan in the mouth without using impression material) to create the prosthesis. After scanning, a laboratory can create and manufacture the permanent crown or bridge, usually using a computer aided design (“CAD”) package.

The utilization of a CAD program is disclosed in U.S. Pat. No. 5,338,198, patented Aug. 16, 1994 by DACAM Laboratory Inc. This patent provided one method of scanning a dental region to create a three dimensional model, namely, that after the impression was taken of the mouth of the patient, the impression material or stone model was placed on a support table defining the X-Y plane. A scanning laser light probe was directed onto the model.

The laser light probe emitted a pulse of laser light that was reflected by the model. A detector received light scattered from the impact of the beam with the impression to calculate a Z-axis measurement. The model and the beam were relatively translated within the X-Y plane to gather a plurality of contact points with known location in the X-Y coordinate plane. The locations of several contact points in the Z-plane were determined by detecting reflected light. Finally, correlating data of the X-Y coordinates and the Z-direction contact points created a digital image. Once a pass was complete, the model may be tilted to raise one side of the mold relative to the opposite vertically away from the X-Y plane. Subsequent to a second scan of the model, the model may be further rotated to allow for a more accurate reading of the model. After all scans were complete, the data may be fed into a CAD system for manipulation of this electronic data by known means.

Photographic imaging was also used to scan either impression material, or a stone model or to scan directly in the mouth. U.S. Pat. No. 5,851,115, patented Dec. 22, 1998 by Nobel Biocare AB taught one system that took photographs at multiple angles in one exposure to scan a dental region, create a model and manufacture a prosthetic tooth This process is generally initiated with the process of taking a stereophotograph with a camera from approximately 50 to 150 mm away from the mouth of the patient The stereophotograph involved a photograph of the mouth of a patient already prepared with implantation devices. Correct spatial positioning of the dental implants was obtained by marking the implant in several locations. The resulting photograph presented multiple images of the same object. The images on the photographs were scanned with a reading device that digitized the photographs to produce a digital image of the dental region. The data from the scanner was electronically transmitted to a graphical imaging program that created a model that was displayed to the user. After identification of the shape, position and other details of the model, the ultimate step was the transmission of the data to a computer for manufacturing.

A third scanning measure used mechanical sensing U.S. Pat. No. 5,652,709 patented Jul. 29, 1997 by Nobel Biocare AB provided such a scanning measure to read a dental model and produce a prosthetic tooth. The impression model was secured to a table that rotated about its longitudinal axis as well as translated along the same axis with variable speeds. A mechanical sensing unit was placed in contact with the model at a known angle and the sensing equipment was held firmly against the surface of the model by a spring. When the model was rotated and translated, the sensing equipment measured the changes in the contour and created an electronic representation of the data. A computer then processed the electronic representation and the data from the scanning device to create a data array. The computer then compressed the data for storage and/or transmission to milling equipment.

To create a permanent prosthesis, the dental region is scanned, as described above, from a stone model, from the impression material, or directly in the mouth using a laser scanning technique, a photographic scanning technique, or a mechanical sensing technique. Stereophotographic imaging is one method used for scanning by performing the technique directly on the mouth cavity of the patient A clinician can photograph implants and other components that have been placed into or adjacent the jawbone of the patient.

The scanned information is then transferred into a graphical imaging program for analysis. The graphical imaging software program, due to the information markers on the surface of the healing abutment, can perform a wide variety of functions. The graphical imaging program can scan an opposing cast in order to develop an opposing occlusal scheme and relate this information back to the primary model. This feature is extremely important because many patients have implants in both maxillary and mandibular locations.

The graphical imaging software program is capable of generating a three-dimensional image of the emergence profile contours used on the healing abutment. If the implant is not placed in the desired esthetic location, the software program relocates the position of the restoration emergence through the soft tissue. The graphical imaging software program is also able to accurately relate the gingival margin for all mold, model, implant, and abutment dimensions. The software creates a transparent tooth outline for superimposition within the edentulous site. The occlusal outline of the “ghost” tooth should, if possible, be accurate and based on the scanned opposing occlusal dimensions. It is contemplated in accordance with the present invention that an occlusal outline is created virtually by computer or by scanning a wax-up in order to maintain a proper plane of occlusion and healing abutment height.

The software program subtracts a given dimension from the mesial, distal, buccal, lingual, and occlusal areas of the superimposed tooth dimension. This allows for an even reduction of the healing abutment during fabrication for proper thickness of the overlying materials (e.g., gold, porcelain, targis, etc.). The graphical imaging software program also incorporates angulation measurements into the custom abutment and subsequently calculates the dimensions of the prosthesis that are checked and modified, if necessary, by a laboratory technician. Each of the features is analyzed and determined from the different information markers that exist on the healing abutments.

The final dimensional information determined by the graphical imaging computer program is transferred from the computer to a milling machine to fabricate the custom abutment.

Some prior art patent which relate to techniques involved in providing dental implants include the following:

U.S. Pat. No. 6,558,162 patented May 6, 2003 by Implant Innovations Inc. provided a healing abutment for attachment to a dental implant with information markers provided thereon and a method for making the same. The implant had an apical end installed into a jawbone having overlying gingiva and a gingival end near an interface of the gingiva and the jawbone with a hexagonal boss (or female) thereon. The healing element comprised information markers for determining the orientation of said hexagonal boss, the diameter of said healing element, the height of said healing element, and the size of said implant. The healing element included the following: a side surface for engaging gingiva; a first type of marking indicative of a first characteristic of the healing element, the first type of marking including a surface protruding outwardly from the top surface, the first characteristic also being an orientation of a polygonal socket within the healing element, the polygonal socket being a hexagonal socket and the first type of marking includes at least two features on the top surface, each of the at least two features being located, relative to a central axis of the healing element, at the same circumferential position as one of the six corners of the hexagonal or triangular socket. A second type of marking indicative of a second characteristic of the healing element, the second type of marking being different from the first type of marking. The first characteristic being an orientation of a polygonal socket within the healing element, the polygonal socket being a hexagonal socket; a second type of marking indicative of a second characteristic of healing element, the second type of marking being different from the first type of marking. The information markers of the healing abutment provide the required information of the gingival aperture and the orientation of the underlying hexagonal boss on the implant.

U.S. Pat. No. 6,790,040, patented Sep. 14, 2004 by Implant Innovations Inc provided healing abutments for use in taking impressions for attachment to a dental implant with marking locations thereon. The marking locations either lacked markers or had markers that provided a binary code system (or any other manner or marking) for retrieving unique information about the healing abutment and the underlying implant. The patented healing abutment had a plurality of external marking locations where markers were either present or absent. Due to the presence or absence of the markers, the physical characteristics of the healing abutment were identifiable through use of a binary-coded system. A set of healing abutments was provided, each of which had unique physical characteristics and a unique binary marking code that indicate those unique physical characteristics. In the patented healing abutment, the presence or absence of the binary-coded markers in the marking locations was said to allow the dentist to determine various physical characteristics, such as the healing abutment height, healing abutment diameter, dimensions of the attached implant seating surface, and the orientation of the implant's fitting. These marking locations containing the binary-coded markers may be either located on the top of the healing abutment, or on the side of the healing abutment. Other patents include:

U.S. Pat. No. 6,769,913, patented Aug. 3, 2004 by Hurson;

U.S. Pat. No. 6,978,188, patented Dec. 20 2005 by Medical Modeling;

U.S. Pat. No. 6,921,264, patented Jul. 26, 2005 by Woodwelding AG;

U.S. Pat. No. 6,869,282, patented Mar. 22 2005 by R. P. Carmicheal; and

U.S. Pat. No. 5,688,123, patented Nov. 18, 1997 by Meiers et al.

### SUMMARY OF THE INVENTION

It would be desirable to provide novel hollow cylindrical custom impression transfer copings which are specially configured to be used with the prior art healing abutments.

It would be desirable to provide a method for the preparation of a dental model.

It would be desirable to provide a method for the preparation of a provisional or temporary restoration extra orally (outside of the oral cavity).

It would be desirable to provide a method accurately to transfer accurately the position of the implant fixture to a laboratory model in situations of tissue overgrowth without the removal of the healing abutment until the permanent custom abutment is ready to be installed in the mouth of the patent.

It would also be desirable to provide a method which eliminates the step of index fabrication by the surgeon during the second stage of the implantation procedure.

It would also be desirable to provide a method which still allows for the creation of a fixture level implant tissue model and a CAD/CAM custom milled prosthetic abutment for the fabrication of the final prosthesis without the removal of the healing abutment.

It would also be desirable to provide a method which allows the clinician to take an impression or index of the coded healing abutment in all situations and allows the fabrication of the final prosthetic abutment and the final prosthesis without ever having to take off the coded healing abutment or without having to take a fixture level index during the surgical phase (or a fixture level impression during the restorative phase).

It would also be desirable to provide a method which allows for the fabrication of a provisional (temporary) restoration immediately after surgery without the removal of the healing abutment.

It would also be desirable to provide a method for the fabrication of a custom milled abutment using CAD/CAM technology without the removal of the healing abutment in situations where the healing abutment is below the free gingival margin, or above the free gingival margin, or at the free gingival margin.

### STATEMENT OF INVENTION

By one broad aspect of the present invention, a hollow cylindrical custom impression transfer coping is provided. Such hollow cylindrical custom impression transfer coping includes:

a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to be used. Such hollow cylindrical custom impression transfer coping further includes an injection port therein to enable the introduction into the volume within the hollow cylindrical custom impression transfer coping below the roof thereof, of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue.

By a second broad aspect of the present invention, a hollow cylindrical custom impression transfer coping is provided. Such hollow cylindrical custom impression transfer coping includes a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to be used. Such hollow cylindrical custom impression transfer coping further includes radially-extending stop members extending from the lower end of the central stop rod, thereby to create two individual impression chambers which are so configured as to be accessed from the occlusal surface. Such hollow cylindrical custom impression transfer coping further includes an injection port therein to enable the introduction into the volume within the hollow cylindrical custom impression transfer coping below the roof thereof, of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue, including radially-extending stop members extending from the lower end of the central thereby to create two individual impression chambers impression chambers which are so configured as to be accessed from the occlusal surface.

By a second broad aspect of the present invention, a hollow cylindrical custom impression transfer coping is provided. Such hollow cylindrical custom impression transfer coping includes a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to be used. Such hollow cylindrical custom impression transfer coping further includes radially-extending stop members extending from the lower end of the central stop rod, thereby to create two individual impression chambers impression chambers which are so configured as to be accessed from the occlusal surface. Such hollow cylindrical custom impression transfer coping further includes an injection port therein to enable the introduction into the volume within the hollow cylindrical custom impression transfer coping below the roof thereof, of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue.

By a third broad aspect of the present invention, a hollow cylindrical custom impression transfer coping is provided. Such hollow cylindrical custom impression transfer coping includes a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to be used. Such hollow cylindrical custom impression transfer coping further includes four radially-extending supporting cross and stop members extending from the vertical stop to the inner cylindrical surfaces of the custom impression transfer coping, thereby to create four injection chambers, each of which are open from the occlusal surface. Such hollow cylindrical custom impression transfer coping further includes an injection port therein to enable the introduction into the volume within the hollow cylindrical custom impression transfer coping below the roof thereof, of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue.

By a fourth broad aspect of the present invention, a hollow cylindrical custom impression transfer coping is provided. Such hollow cylindrical custom impression transfer coping includes a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to be used. Such hollow cylindrical custom impression transfer coping further includes four radially-extending supporting cross and stop members extending from the vertical stop to the inner cylindrical surfaces of the custom impression transfer coping, thereby to create four injection chambers, each of which are open from the occlusal surface. Such hollow cylindrical custom impression transfer coping further includes an injection port therein to enable the introduction into the volume within the hollow cylindrical custom impression transfer coping below the roof thereof, of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue.

By a fifth broad aspect of the present invention, a hollow cylindrical custom impression transfer coping is provided. Such hollow cylindrical custom impression transfer coping includes

a central connecting rod upstanding from the roof of the hollow cylindrical custom impression transfer coping, the central connecting rod including at least two upper retention rings defining at least one retention groove therebetween. Such hollow cylindrical custom impression transfer coping further includes a central stop rod depending from the roof of the hollow cylindrical custom impression transfer coping, the central stop rod having a curved lower edge to conform to a healing abutment with which it is adapted to-be used. Such hollow cylindrical custom impression transfer coping further includes an injection port therein, through to a shoulder of the hollow cylindrical custom impression transfer coping below the roof thereof from which the hollow cylinder depends, to enable the introduction into the volume within the hollow cylindrical custom impression transfer coping of light curable or self curing material. Such hollow cylindrical custom impression transfer coping further includes a beveled lower circumferential edge of the hollow cylindrical custom impression transfer coping to enable the hollow cylindrical custom impression transfer coping to slide under tissue.

By a sixth broad aspect of the present invention a method is provided for the preparation of a dental model. The method includes placing a custom impression transfer coping on a coded healing abutment intraorally. The method further includes injecting a fluid or gel material through an access hole in the rear into an air chamber created by said custom impression transfer coping. The method further includes solidifying the material to a very rigid and hard form. The method further includes taking an impression using dental impression material to capture the soft and hard tissues and the custom impression transfer coping. The method further includes placing a duplicate healing abutment and implant replica (analog) unit into the custom impression transfer coping in a correct orientation to be fully seated. The method further includes flowing gingival mask material around the healing abutment and implant unit. The method further includes pouring the impression in dental stone to produce a replica of the implant and healing abutment intraorally. The method further includes preparing the final prosthesis through conventional laboratory techniques.

By a seventh broad aspect of the present invention a method is provided for the preparation of a provisional or temporary restoration. The method includes placing a rubber dam first over the surgical site and a coded healing abutment. The method further includes placing a custom impression transfer coping on said coded healing abutment intra orally in such a manner that the rubber dam is held in place covering the surgical site and sutures from impression procedures. The method further includes injecting a fluid or gel material through an access hole in the rear into an air chamber created by said custom impression transfer coping. The method further includes solidifying the material to a very rigid and hard condition. The method further includes taking an impression using dental impression material to capture the soft and hard tissues and the custom impression transfer coping. The method further includes placing a duplicate healing abutment and implant replica (analog) unit into the custom impression transfer coping in a correct orientation to be fully seated. The method further includes flowing gingival mask material around the healing abutment and implant unit. The method further includes pouring an impression in dental stone to produce a replica of the implant and healing abutment intra orally. The method further includes preparing the provisional (temporary) restoration through conventional laboratory techniques.

### OTHER FEATURES OF THE INVENTION

By a first feature of the first aspect of the present invention, the central stop rod is configured to cover the screw access hole during the dental impression procedure, to prevent the healing abutment from becoming covered by the dental impression material.

By another feature of the first aspect of the present invention, the central stop rod is configured to cover the screw access hole during the dental impression procedure and to provide a retentive device to provide stability within the impression once the impression has been taken.

By another feature of the first aspect of the present invention, the hollow cylindrical custom impression transfer coping is made of any suitable material, e.g., plastic or of metal.

By another feature of the first aspect of the present invention, the hollow cylindrical custom impression transfer coping is made in different sizes depending on the size of the corresponding healing abutment.

By another feature of the first aspect of the present invention, the injection port is located in the upper peripheral sidewall thereof

By another feature of the first aspect of the present invention, the hollow cylindrical custom impression transfer coping includes more than one injection port to allow for the escape of air from the interior of the custom impression transfer coping as the light cured or self curing material is being injected.

By another feature of the first aspect of the present invention, the hollow cylindrical custom impression transfer coping includes retention holes or protuberances on the retention rings or in the areas of the retention grooves.

By another feature of the first aspect of the present invention, the hollow cylindrical custom impression transfer coping has dissimilar shapes and sizes of the retention rings, thereby to prevent the rotation and/or improper positioning of the custom impression transfer coping.

By another feature of the first aspect of the present invention, the hollow cylindrical custom impression transfer coping has dissimilar shapes and sizes of the retention grooves, thereby to prevent the rotation and/or positioning of the custom impression transfer coping.

By a first feature of the second aspect of the present invention, the individual impression chambers are so configured as to be accessed from the occlusal surface.

By another feature of the second aspect of the present invention, the individual impression chambers are so configured as to receive light cured or self-curing material which is injected thereinto to capture the markings on the healing abutment.

By another feature of the second aspect of the present invention, the hollow cylindrical custom impression transfer coping has less than two or more than two retention rings and thus has either less than two or more than two retention grooves.

By another feature of the second aspect of the present invention, the hollow cylindrical custom impression transfer coping has retention holes or protuberances on the retention rings or in the areas of the retention grooves.

By another feature of the second aspect of the present invention, the hollow cylindrical custom impression transfer coping has dissimilar shapes and sizes of the retention rings so as to prevent the rotation and/or improper positioning of the custom impression transfer coping.

By another feature of the second aspect of the present invention, the hollow cylindrical custom impression transfer coping has dissimilar shapes and sizes of the retention grooves so as to prevent the rotation and/or improper positioning of the custom impression transfer coping.

By a first feature of the third aspect of the present invention, the radially-extending stop members are so configured as to be in contact with the healing abutment and so are configured to conform to the shape and contour of the healing abutment.

By another feature of the third aspect of the present invention, the light cured or self-curing material is injectable into each of the individual impression chambers to capture the markings on the healing abutment.

By another feature of the third aspect of the present invention, the radially-extending stop members are so configured as to be of a greater height than the lower vertical stop members, so as not to be in direct contact with the healing abutment, and to create a space between the lower vertical stop members and the healing abutment to accommodate the light cured or self-curing material.

By another feature of the third aspect of the present invention, the hollow cylindrical custom impression transfer coping has less than three lower vertical stop members, thereby providing one individual impression chamber.

By another feature of the third aspect of the present invention, the hollow cylindrical custom impression transfer coping has more than three lower vertical stop members, thereby providing a plurality of individual impression chamber.

By other features of the third aspect of the present invention, the hollow cylindrical custom impression transfer coping has less than two retention rings and thus has less than two retention grooves, or has more than two retention rings and thus more than two retention grooves.

By other features of the third aspect of the present invention, the hollow cylindrical custom impression transfer coping has retention holes or protuberances on the retention rings, or has retention holes or protuberances in the areas of the retention grooves.

By other features of the third aspect of the present invention, the hollow cylindrical custom impression transfer coping has dissimilar shapes and sizes of the retention rings, thereby to prevent the rotation and/or improper positioning of the custom impression transfer coping, or has dissimilar shapes and sizes of the retention grooves, thereby to prevent the rotation and/or improper positioning of the custom impression transfer coping.

By a first feature of the fourth aspect of the present invention, the lower surfaces of the four radially-extending supporting cross and stop members are so configured as to be in contact with the healing abutment and to conform to the shape and contour of the healing abutment.

By another feature of the fourth aspect of the present invention, the light cured or self-curing material is injectable into each of the injection chambers to capture the markings on the healing abutment.

By another feature of the fourth aspect of the present invention, the hollow cylindrical custom impression transfer coping has retention wings thereon.

By another feature of the fourth aspect of the present invention, the hollow cylindrical custom impression transfer coping includes an increase in wall height between the four radially-extending supporting cross and stop members and the retention wings, thereby to create an additional chamber space for increased retention of the light cured or self-curing material.

By another feature of the fourth aspect of the present invention, the hollow cylindrical custom impression transfer coping includes one or more horizontal wings attached to the outer cylindrical surface of the custom impression transfer coping, thereby to allow for a lower profile custom impression transfer coping.

By another feature of the fourth aspect of the present invention, the hollow cylindrical custom impression transfer coping has retention holes, grooves or protuberances on the outer cylindrical surface of the custom impression transfer coping for additional retention of the custom impression transfer coping with the impression material.

By another feature of the fourth aspect of the present invention, the wings attached to the outer cylindrical surface of the custom impression transfer coping are of horizontal spiral or any other variation in shape or orientation which aids in the retention of the custom impression transfer coping with the impression material.

By another feature of the fourth aspect of the present invention, the vertical stop is of a greater height than the four radially-extending supporting cross and stop members so that the lower surfaces of the four radially-extending supporting cross and stop members are not in direct contact with the healing abutment, thereby to create a space between the lower surfaces of the four radially-extending supporting cross and stop members and the healing abutment for increased retention of the light cured or self-curing material.

By other features of the fourth aspect of the present invention, the hollow cylindrical custom impression transfer coping has less than four supporting cross and stop members, thereby providing one individual impression chamber, or has more than four supporting cross and stop members, thereby providing a plurality of individual impression chamber.

By a first feature of the fourth aspect of the present invention, the lower surfaces of the hollow cylindrical custom impression transfer coping has more than one injection port, to allow for the escape of air from the interior of the custom impression transfer coping as the light cured or self curing material is being injected.

By other features of the fourth aspect of the present invention, the hollow cylindrical custom impression transfer coping has less than two retention rings, and thus less than two retention grooves, or has more than two retention rings, and thus more than two retention grooves.

By other features of the fourth aspect of the present invention, the lower surfaces of the hollow cylindrical custom impression transfer coping has retention holes or protuberances on the retention rings, or has retention holes or protuberances in the areas of the retention grooves.

By other features of the fourth aspect of the present invention, the hollow cylindrical custom impression transfer coping has dissimilar shapes and sizes of the retention rings, thereby to prevent the rotation and/or improper positioning of the custom impression transfer coping, or has dissimilar shapes and sizes of the retention grooves, thereby to prevent the rotation and/or improper positioning of the custom impression transfer coping.

The foregoing summarizes the principal features of the invention and some of its optional aspects. The invention may be further understood by the description of the preferred embodiments, in conjunction with the drawings, which now follow.

### BRIEF DESCRIPTION OF THE DRAWINGS

In the accompanying drawings:

FIG. 1 is a top view of one embodiment of a healing abutment according to the prior art which is adapted to be used with one embodiment of the impression transfer coping of one aspect of the present invention;

FIG. 2 is a longitudinal cross-sectional view of the healing abutment shown in FIG. 1;

FIG. 3 is a longitudinal cross-sectional view of a custom impression transfer coping according to one embodiment of an aspect of the present invention;

FIG. 4 is a longitudinal cross-sectional view of a custom impression transfer coping according to a second embodiment of an aspect of the present invention;

FIG. 5 is a longitudinal cross-sectional view of a custom impression transfer coping according to a third embodiment of an aspect of the present invention; and

FIG. 6 is a horizontal cross-sectional view of a custom impression transfer coping according to a fourth embodiment of an aspect of the present invention.

FIG. 7 is a horizontal cross-sectional view of a custom impression transfer coping according to a fifth embodiment of an aspect of the present invention; and

FIG. 8 is a longitudinal cross-sectional view of a custom impression transfer coping according to the fifth embodiment of an aspect of the present invention.

### DESCRIPTION OF THE PRIOR ART HEALING ABUTMENT

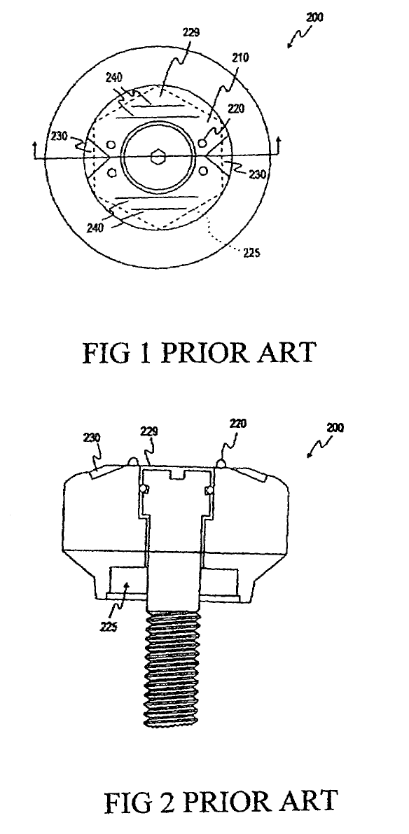

The healing abutment 200 shown in FIGS. 1 and 2, displays four positive information markers 220 shown, for example, to indicate a 4-mm tall healing abutment 200. It is contemplated that the number of information markers 220 could decrease or increase depending on the height of the healing abutment 200 or another variable that the information markers have been designated to correspond. The positive (or negative or laser) information markers 220 also define a corresponding one of the six flat surfaces of an underlying hex 225. Furthermore, dashed lines 225 in FIG. 2 correspond directly to the underlying hex 225.

Two notches 230 have also been etched or machined onto a top surface 229 of the healing abutment of FIG. 2. These notches may indicate the diameter of the implant's seating surface. Lines 240 are scribed on the top surface 229 of the healing abutment 200. The lines 240 are used to provide positioning or other information to the dentist or laboratory. Here, the lines 240 indicate the diameter of the healing abutment (e.g., 4 mm). In summary, the number of the positive information markers 220 indicates the height of the healing abutment 200. The position of the positive information markers 220 indicates the orientation of the hex 225 that is the orientation of the hexagonal boss on the implant. The notches 230 indicate the diameter of the seating surface of the implant The lines 240 indicate the diameter of the healing abutment 200.

### Description of Illustrative Embodiments

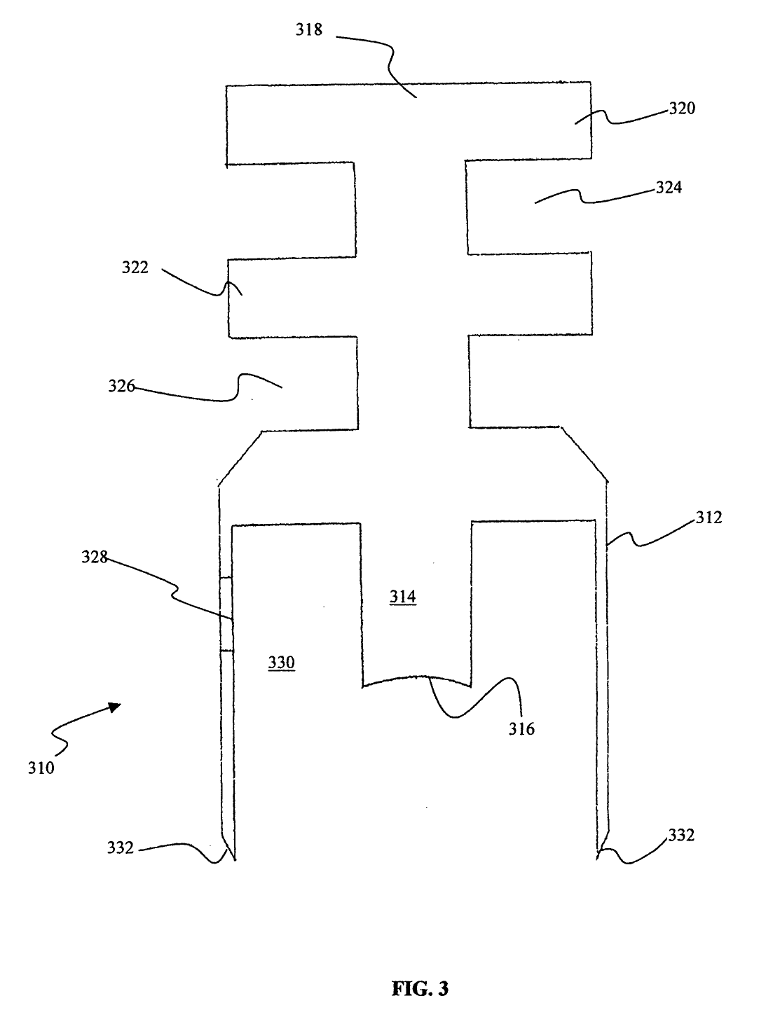

### Description of FIG. 3

The custom impression transfer coping 310 shown in FIG. 3 is generally a hollow cylindrical body 312 and depending stem 314 terminating in an arcuate vertical or initial positive stop 316. This arcuate vertical or initial positive stop 316 is arcuately curved to conform to the healing abutment (previously described above with reference to FIGS. 1 and 2) and also acts to cover the screw access hole during the dental impression procedure as previously described. The custom impression transfer coping 310 includes an upwardly projecting central stem 318 provided with an upper retention ring 320 and a lower retention ring 322, which provide an upper retention groove 324 and a lower retention groove 326. The custom impression transfer coping 310 is also provided with an injection port 328 which leads of the hollow interior 330 of the custom impression transfer coping 310. The lower peripheral edge of the custom impression transfer coping 310 is beveled at 332 to enable the custom impression transfer coping 31 0 to slide under the tissue.

Once the custom impression transfer coping 310 is placed on the healing abutment e.g., the. healing abutment shown in FIG. 1 and FIG. 2, the arcuate vertical or initial positive stop 316 creates an air chamber. The injection port 328 of the cylindrical custom impression transfer coping 310 enables the placement of a syringe-type dispensing device for the injection of light curable or self curing material. The arcuate vertical or initial positive stop 316 also covers the screw hole of the healing abutment 200 to prevent the healing abutment 200 from becoming covered by the dental impression material. In addition, the arcuate vertical or initial positive stop 316 of the custom impression transfer coping 310 acts as a retentive device to provide stability within the impression once the impression has been taken.

The custom impression transfer coping 310 can be made of any suitable material, e.g., of plastic or of metal. Furthermore, the custom impression transfer coping 310 can be made in different sizes depending on the size of the corresponding healing abutment 200.

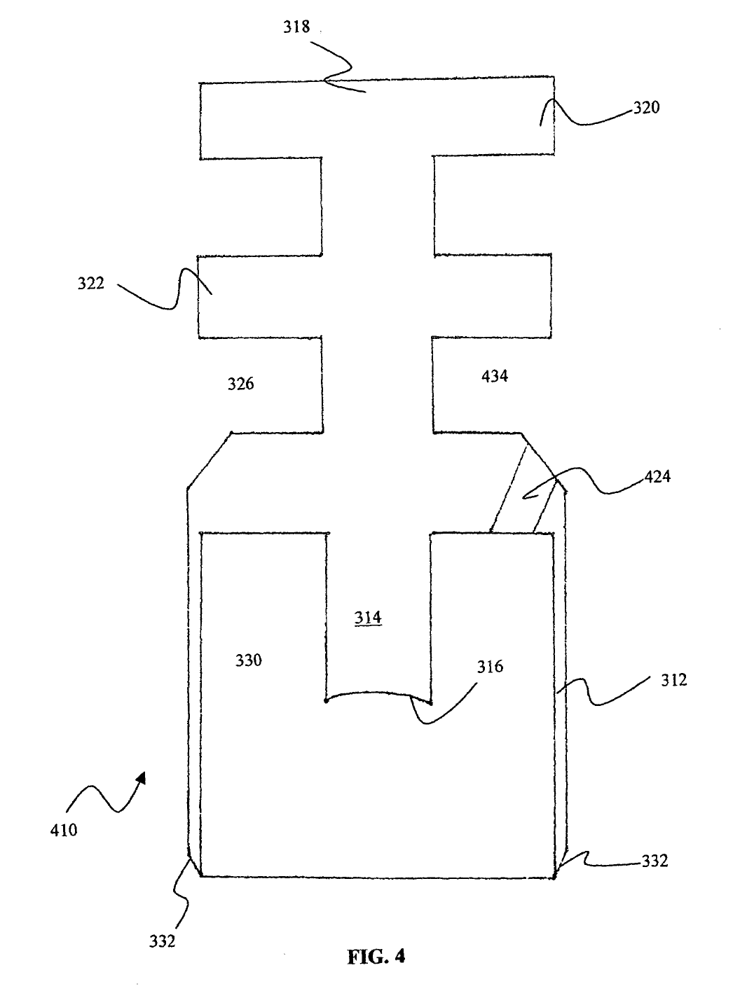

### Description of FIG. 4.

The second illustrated embodiment of the custom impression transfer coping 410 is almost identical to the first embodiment of the custom impression transfer coping 310, and to the extent that parts are similar, no further description will be given.

In the embodiment shown, the injection port 424 is located in the shoulder 434 of the hollow cylinder 312.

Other embodiments of the first embodiment of the custom impression transfer coping 310 are the following, although they are not shown.

The custom impression transfer coping 310 may have more than one injection port 328, to allow for the escape of air from the interior 330 of the custom impression transfer coping 310 as the light cured or self curing material is being injected.

The custom impression transfer coping 310 may have less than two or more than two retention rings 320, 322 and thus less than two or more than two retention grooves 324, 326.

The custom impression transfer coping 310 may have retention holes or protuberances on the retention rings 320, 322 or in the areas of the retention grooves 324, 326.

The custom impression transfer coping 310 may have dissimilar shapes and sizes of the retention rings 320,.322 and/or may have dissimilar shapes and sizes of the retention grooves 324, 326 which could prevent the rotation and/or position of the custom impression transfer coping 310.

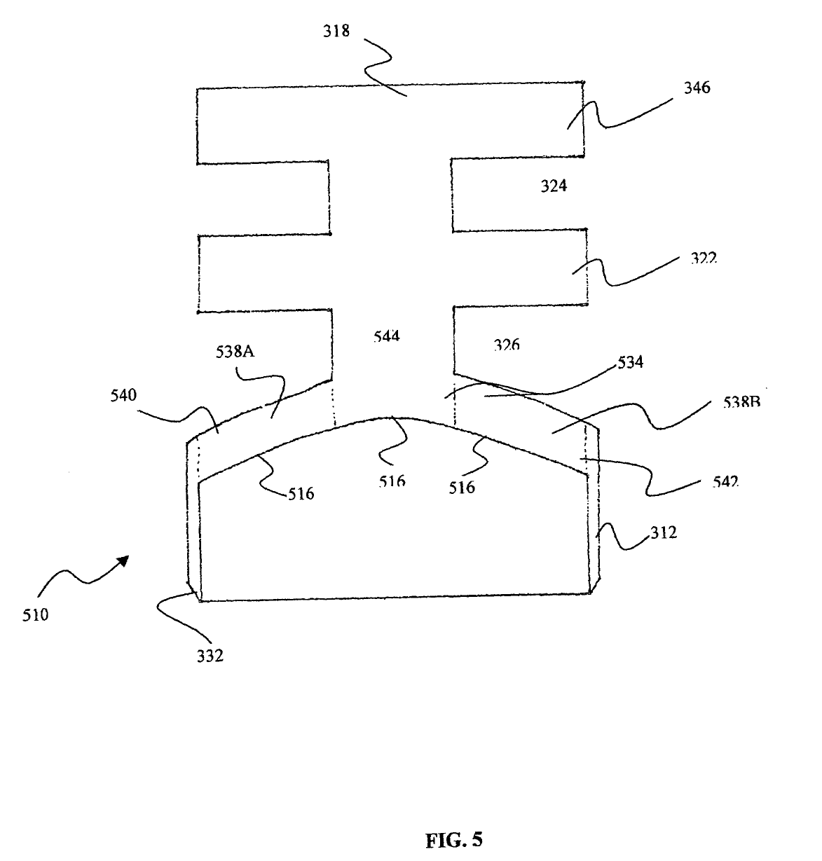

### Description of FIG. 5

The third illustrated embodiment of the custom impression transfer coping 510 is almost vertical stop members identical to the first embodiment of the custom impression transfer coping 310, and to the extent that parts are similar, no further description will be given

In the embodiment shown, radially-extending stop members 540, 542 extend from the lower end 544 of the central stem 318. These stop members 542, 544 create two individual impression chambers 538A, 538B. The radially-extending stop members 540, 542 are adapted to be in contact with the healing abutment 200, and so conform, by lower vertical stop members 516, to the shape and contour of the healing abutment 200. The individual impression chambers 538A, 538B are adapted to be accessed from the occlusal surface. The light cured or self-curing material can be injected into each of the individual impression chambers 538A, 538B to capture the markings on the healing abutment 200.

Other embodiments of the third illustrated embodiment of the custom impression transfer coping 510 are the following, although they are not shown.

The custom impression transfer coping 510 may have less than two or more than two retention rings 320, 322 and thus less than two or more than two retention grooves 324, 326.

The custom impression transfer coping 510 may have retention holes or protuberances on the retention rings 320, 322 or in the areas of the retention grooves 324, 326.

The custom impression transfer coping 510 may have dissimilar shapes and sizes of the retention rings 320, 322 and/or may have dissimilar shapes and sizes of the retention grooves 324, 326 which could prevent the rotation and/or position of the custom impression transfer coping 310.

The custom impression transfer coping 510 may form the radially-extending stop members 540, 542 of a greater height than the lower vertical stop members 516. Thus, the lower vertical stop members 516 would not be in direct contact with the healing abutment 200. A space is therefore created between the lower vertical stop members 516 and the healing abutment 200. This space can accommodate the light cured or self-curing material. The lower vertical stop members 516 may or may not conform to the shape of the healing abutment.

The custom impression transfer coping 510 may include less than three lower vertical stop members 516, or more than three lower vertical stop members 516, thereby providing one individual impression chamber 538A, 538B, or a plurality of individual impression chamber 538A, 538B.

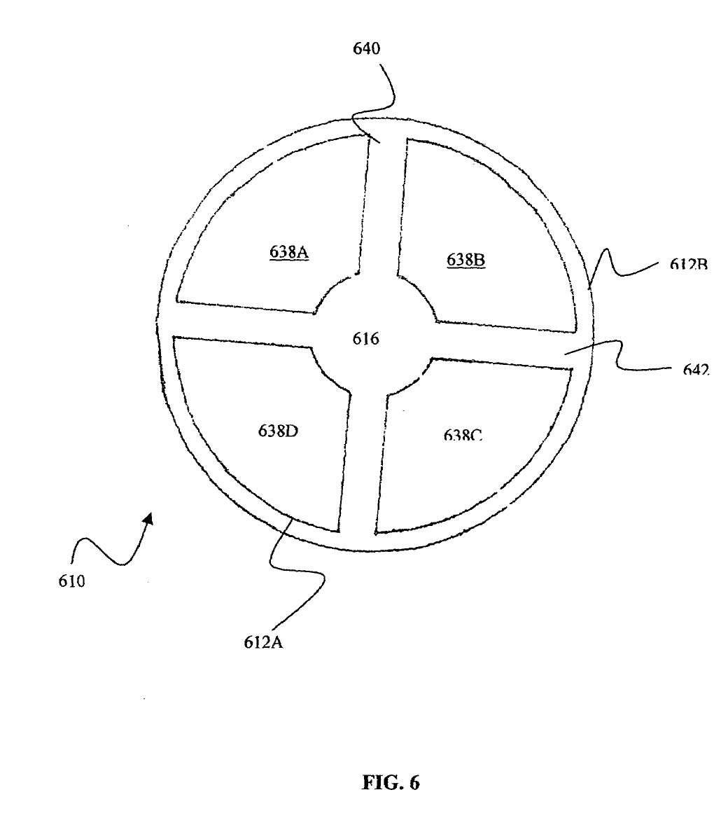

### Description of FIG. 6

The fourth illustrated embodiment of the custom impression transfer coping 610 is almost identical to the third embodiment of the custom impression transfer coping 510, and to the extent that parts are similar, no further description will be given.

In the embodiment shown, four radially-extending supporting cross and stop members 640, 642, 644 and 646 extend from the vertical stop 616 to the inner cylindrical surfaces 612A of the custom impression transfer coping 610.This creates four injection chambers 638A, 638B, 638C and 638D, each of which are open from the occlusal surface. The cross members, i.e., the lower surfaces of the four radially-extending supporting cross and stop members 640, 642, 644 and 646 are in contact with the healing abutment 200 and conform to the shape and contour of the healing abutment 200. The light cured or self-curing material can be injected into each of the injection chambers 638A, 638B, 638C and 638D, to capture the markings on the healing abutment 200.

Other embodiments of the third illustrated embodiment of the custom impression transfer coping 610 are the following, although they are not shown.

The custom impression transfer coping 610 may include an increase in wall height between the four radially-extending supporting cross and stop members 640, 642, 644 and 646 and retention wings, thereby to create an additional chamber space for increased retention of the light cured or self-curing material.

The custom impression transfer coping 610 can have retention holes, grooves or protuberances on the outer cylindrical surface 612B of the custom impression transfer coping 610 for additional retention.

The custom impression transfer coping 610 may have the vertical stop 616 of a greater height than the four radially-extending supporting cross and stop members 640, 642, 644 and 646 so that the lower surfaces of the four radially-extending supporting cross and stop members 640, 642, 644 and 646 are not in direct contact with the healing abutment 200. This creates a space between the lower surfaces of the four radially-extending supporting cross and stop members 640, 642, 644 and 646 and the healing abutment 200 for the for increased retention of the light cured or self-curing material. The lower surfaces of the four radially-extending supporting cross and stop members 640, 642, 644 and 646 thus may or may not conform to the shape of the healing abutment 200.

The custom impression transfer coping 610 may include less than four supporting cross and stop members 640, 642, 644 and 646, or more than four supporting cross and stop members 640, 642, 644 and 646 thereby providing at least one individual impression chamber 638A, or a plurality of individual impression chamber 638A etc.

The custom impression transfer coping 610 may form the radially-extending stop members 640, 642 of a greater height than the lower vertical stop members 616. Thus, the lower vertical stop members 616 would not be in direct contact with the healing abutment 200. A space is therefore created between the lower vertical stop members 616 and the healing abutment 200. This space can accommodate the light cured or self-curing material. The lower vertical stop members 516 may or may not conform to the shape of the healing abutment

The custom impression transfer coping 610 may include less than three lower vertical stop members 616, or more than three lower vertical stop members 516, thereby providing at least one individual impression chamber 538A, or a plurality of individual impression chamber 538A, 538B. etc.

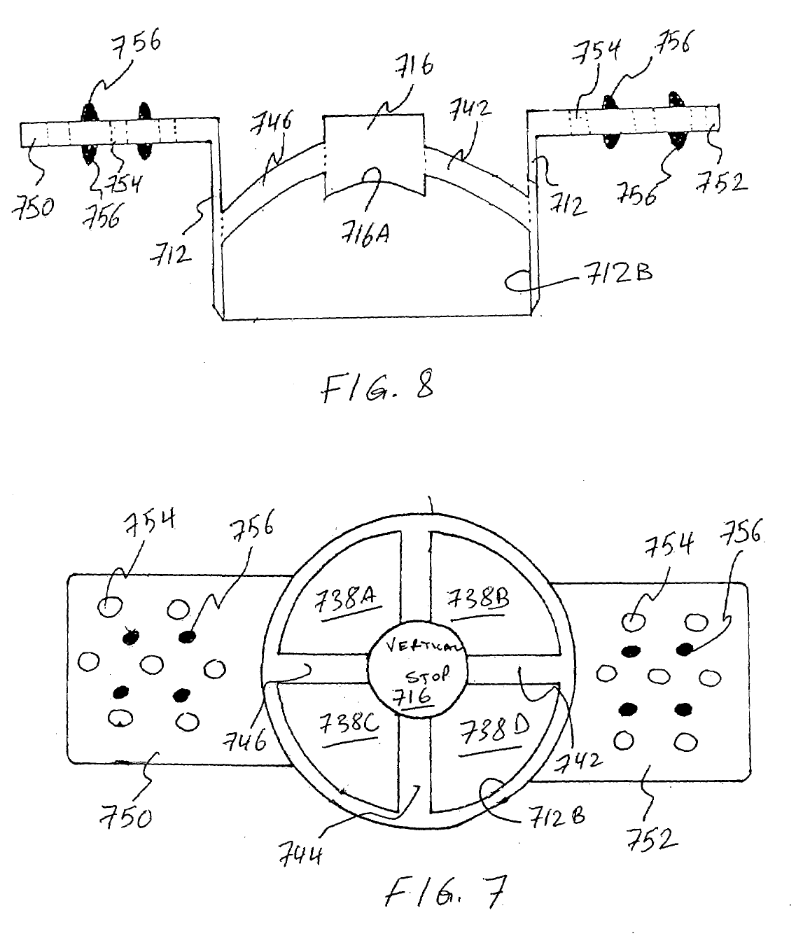

### Description of FIG. 7 and FIG. 8

The fifth illustrated embodiment of the custom impression transfer coping 710 is similar to the fourth embodiment of the custom impression transfer coping 610, and to the extent that parts are similar, no further description will be given

In the embodiment shown, four radially-extending supporting cross and stop members 740, 742, 744 and 746 extend from the vertical stop 716 to the inner cylindrical surfaces 712A of the custom impression transfer coping 710. This creates four injection chambers 738A, 738B, 738C and 738D, each of which are open from the occlusal surface. The cross members, i.e., the lower surfaces of the four radially-extending supporting cross and stop members 740, 742, 744 and 746 are in contact with the healing abutment 200 and conform to the shape and contour of the healing abutment 200. The light cured or self-curing material can be injected into each of the injection chambers 738A, 7388B, 738C and 738D, to capture the markings on the healing abutment 200.

As seen more clearly by the combined effect of FIG. 7 and FIG. 8, the four radially-extending supporting cross and stop members 740, 742, 744 and 746 which extend from the vertical stop 716 to the inner cylindrical surfaces 712A are downwardly arched so the the vertical stop 716 is at a higher plane than the four radially-extending supporting cross and stop members 740, 742, 744 and 746. The cylindrical wall 712 of the custom impression transfer coping 710 terminates in an upper pair of horizontally-projecting retention wings 748, 750. The pair of horizontally-projecting retention wings 748, 750 each are provided with a plurality of retention protruberances 752 and with a plurality of retention apertures 754.

The four individual injection chambers 738A, 738B, 738C and 738D are created by having the supporting cross-members 740, 742, 744 and 746 extend from the vertical stop member 716 to the outer ring 712 of the impression coping 710.The cross-members 740, 742, 744 and 746 are in contact with the healing abutment 200, and conform to the shape and contour of the healing abutment 200. As mentioned hereinabove, the four individual injection chambers 738A, 7388B, 738C and 738D can be accessed from the occlusal surface and the light cured or self-curing material can be injected into each of the injection chambers 738A, 738B, 738C and 738D.

The major benefit of the fifth embodiment of the transfer coping is the lower profile. The lower profile allows an operator to take an impression of the healing abutment using the triple tray technique. The triple tray technique allows an operator to take an impression of the healing abutment, the opposing arch and the bite registration in one simple procedure. By simultaneously capturing upper and lower impression plus the bite registration, significant time is saved at the dental chair. The closed mouth technique frees the operator from holding the tray in place.

Other embodiments of the third illustrated embodiment of the custom impression transfer coping 710 are the following, although they are not shown.

The custom impression transfer coping 710 may include an increase in wall height between the four radially-extending supporting cross and stop members 740, 742, 744 and 746 and retention wings, thereby to create an additional chamber space for increased retention of the light cured or self-curing material.

The custom impression transfer coping 710 with one or more horizontal wings attached to the outer cylindrical surface 712 of the custom impression transfer coping 710 can also have retention holes, grooves or protuberances on the outer cylindrical surface 712 of the custom impression transfer coping 710 for additional retention.

The custom impression transfer coping 710 with one or more wings attached to the outer cylindrical surface 712 of the custom impression transfer coping 710 can have such one or more such retention wings as a horizontal spiral or any other variation in shape or orientation which aids in the retention of the custom impression transfer coping 710 with the impression material.

The custom impression transfer coping 710 may have the vertical stop 716 of a greater height than the four radially-extending supporting cross and stop members 740, 742, 744 and 746 so that the lower surfaces of the four radially-extending supporting cross and stop members 740, 742, 744 and 46 are not in direct contact with the healing abutment 200. This creates a space between the lower surfaces of the four radially-extending supporting cross and stop members 740, 742, 744 and 746 and the healing abutment 200 for the for increased retention of the light cured or self-curing material. The lower surfaces of the four radially-extending supporting cross and stop members 740, 742, 744 and 746 thus may or may not conform to the shape of the healing abutment 200.

The custom impression transfer coping 710 may include less than four supporting cross and stop members 740, 742, 744 and 746, or more than four supporting cross and stop members 740, 742, 744 and 746, thereby providing at least one individual impression chamber 738A etc, or a plurality of individual impression chamber 738A etc.

The custom impression transfer coping 710 may have dissimilar shapes and sizes of the retention wings and/or may have dissimilar shapes and sizes of retention holes and/or protuberances.

The custom impression transfer coping 710 may have dissimilar shapes and sizes of the retention wings and/or may have dissimilar shapes and sizes of retention holes and/or protuberances which could prevent the rotation and/or position of the custom impression transfer coping 710.

### EXAMPLE 1

### Preparation of a Dental Model

A dental model according to one embodiment of the present invention may be prepared as follows. Firstly, a custom impression transfer coping is placed on the coded healing abutment intraorally. Then, a fluid or gel is injected through the access hole in the rear into the air chamber created by the custom impression transfer coping. The material is solidified through chemical curing or some other method. The material must be very rigid and hard. An impression is then taken using dental impression material to capture the soft and hard tissues and the custom impression transfer coping. A duplicate healing abutment and implant replica (analog) unit is then placed into the custom impression transfer coping in a correct orientation to be fully seated. Gingival mask material is flowed around the healing abutment and implant unit. The impression is poured in dental stone to produce a replica of the implant and healing abutment intraorally.

The final model is prepared through conventional laboratory techniques for the final prosthesis.

### EXAMPLE 2

### Preparation of a Provisional (Temporary) Restoration

A provisional or temporary restoration according to one embodiment of the present invention may be prepared as follows: A rubber dam first is placed over the surgical site and coded healing abutments. A custom impression transfer coping is placed on the coded healing abutment intraaorally in such a manner that the rubber dam is held in place covering the surgical site and sutures from the impression procedures. A fluid or gel is injected through the access hole in the rear into the air chamber created by the custom impression transfer coping. The material is solidified through chemical curing or some other method. The material must be very rigid and hard. An impression is taken using dental impression material to capture the soft and hard tissues and the custom impression transfer coping. A duplicate healing abutment and implant replica (analog) unit is placed into the custom impression transfer coping in a correct orientation to be fully seated. Gingival mask material is flowed around the healing abutment and implant unit. The impression is poured in dental stone to produce a replica of the implant and healing abutment intraorally.

The model is prepared through conventional laboratory techniques for the provisional (temporary) restoration.

### EXAMPLE 3

### Providing the Exact Location and Position of the Dental Implant

The custom impression transfer coping is placed on the implant healing cap, e.g., those shown if FIG. 1 and FIG. 2 herein in the mouth till full stop. Injection material is injected through the access hole into the hollow interior air chamber of the custom impression transfer coping. This injection material is initially in liquid, gel or semi-solid form. Once this injection material is in the air chamber of the custom impression transfer coping it is solidified chemically or by light activation to a solid state. A dental impression is taken. This procedure captures the markings on the healing abutment and transfers them in a solid form to within the impression coping a duplicate implant healing cap and implant analog component is reinserted into the impression.

The impression is poured in dental stone and tissue mask to duplicate what is in the mouth. This gives the exact location and position of the implant.

### CONCLUSION

The following advantages are achieved according to aspects of the present invention:

The product size and process is small enough to work in the confined space of the oral cavity;

The process allows for the fabrication of a custom index in the oral cavity in a way that uses existing dental materials;

The process has very few procedural steps;

The process is capable of being duplicated with consistency;

The process is easily taught and is capable of being easy to implement;

The custom index is wear resistant;

The custom index is rigid and not flexible;

The component piece can be manufactured in a cost effective manner;

The component has resistance to lateral displacement during the impression procedure;

The component includes a mechanism to prevent vertical displacement subgingivally beyond a fixed point;

The component isolates the centre screw of the healing abutment from the procedure;

The proximal end of the component has a retentive element that prevents shifting of the component during impression taking and the laboratory procedure that follows;

The element of the component that is placed sub-gingivally has adequate strength to prevent fracturing during the impression and laboratory procedures and is thin enough to minimize displacement of the gingival tissue; and

The material of the component is biocompatible.

The foregoing has constituted a description of specific embodiments showing how the invention may be applied and put into use. These embodiments are only exemplary. The invention in its broadest and more specific aspects is further described and defined in the claims which follow.

These claims, and the language used therein are to be understood in terms of the variants of the invention which have been described. They are not to be restricted to such variants, but are to be read as covering the full scope of the invention as is implicit within the invention and the disclosure that has been provided herein.

1. A hollow cylindrical custom impression transfer coping comprising:
a central connecting rod upstanding from the roof of the hollow cylindrical custom impression transfer coping, the central connecting rod including at least two upper retention rings defining at least one retention groove therebetween;
a central stop rod depending from the roof of the hollow cylindrical custom impression transfer coping, the central stop rod having a curved lower edge to conform to a healing abutment with which it is adapted to be used;
an injection port therein to enable the introduction into the volume within the hollow cylindrical custom impression transfer coping below the roof thereof, of light curable or self curing material; and
a beveled lower circumferential edge of the hollow cylindrical custom impression transfer coping to enable the hollow cylindrical custom impression transfer coping to slide under tissue.

2. The hollow cylindrical custom impression transfer coping as claimed in claim 1, wherein the central stop rod is configured to cover the screw access hole during the dental impression procedure, to prevent the healing abutment from becoming covered by the dental impression material.

3. The hollow cylindrical custom impression transfer coping as claimed in claim 1, wherein the central stop rod is configured to cover the screw access hole during the dental impression procedure and to provide a retentive device to provide stability within the impression once the impression has been taken.

4. The hollow cylindrical custom impression transfer coping as claimed in claim 1, which is made of any suitable material

5. The hollow cylindrical custom impression transfer coping as claimed in claim 4, which is made of plastic or of metal.

6. The hollow cylindrical custom impression transfer coping as claimed in claim 4, which is made in different sizes depending on the size of the corresponding healing abutment.

7. The hollow cylindrical custom impression transfer coping as claimed in claim 1, wherein the injection port is located in the upper peripheral side wall thereof

8. The hollow cylindrical custom impression transfer coping as claimed in claim 1, including more than one injection port to allow for the escape of air from the interior of the custom impression transfer coping as the light cured or self curing material is being injected.

9. The hollow cylindrical custom impression transfer coping as claimed in claim 1, including retention holes or protuberances on the retention rings or in the areas of the retention grooves

10. The hollow cylindrical custom impression transfer coping as claimed in claim 1, dissimilar shapes and sizes of the retention rings, thereby to prevent the rotation and/or improper positioning of the custom impression transfer coping

12. The hollow cylindrical custom impression transfer coping as claimed in claim 1, having dissimilar shapes and sizes of the retention grooves, thereby to prevent the rotation and/or positioning of the custom impression transfer coping.

13. A hollow cylindrical custom impression transfer coping comprising:
a central connecting rod upstanding from the roof of the hollow cylindrical custom impression transfer coping, the central connecting rod including at least two upper retention rings defining at least one retention groove therebetween;
a central stop rod depending from the roof of the hollow cylindrical custom impression transfer coping, the central stop rod having a curved lower edge to conform to a healing abutment with which it is adapted to be used;
a plurality of radially-extending stop members extending from the lower end of the central stop rod, thereby to create two individual impression chambers impression chambers which are so configured as to be accessed from the occlusal surface;
an injection port therein to enable the introduction into the volume within the hollow cylindrical custom impression transfer coping below the roof thereof, of light curable or self curing material; and
a beveled lower circumferential edge of the hollow cylindrical custom impression transfer coping to enable the hollow cylindrical custom impression transfer coping to slide under tissue.

14. The hollow cylindrical custom impression transfer coping as claimed in claim 13, wherein the individual impression chambers are so configured as to be accessed from the occlusal surface.

15. The hollow cylindrical custom impression transfer coping as claimed in claim 13, wherein the individual impression chambers are so configured as to receive light cured or self-curing material which is injected thereinto to capture the markings on the healing abutment.

16. The hollow cylindrical custom impression transfer coping as claimed in claim 13, having less than two or more than two retention rings and thus less than two or more than two retention grooves.

17. The hollow cylindrical custom impression transfer coping as claimed in claim 13, having retention holes or protuberances on the retention rings or in the areas of the retention grooves.

18. The hollow cylindrical custom impression transfer coping as claimed in claim 13, having dissimilar shapes and sizes of the retention rings so as to prevent the rotation and/or improper positioning of the custom impression transfer coping.

19. The hollow cylindrical custom impression transfer coping as claimed in claim 13, having dissimilar shapes and sizes of the retention grooves so as to prevent the rotation and/or improper positioning of the custom impression transfer coping.

20. The hollow cylindrical custom impression transfer coping as claimed in claim 13, incuding radially-extending stop members extending from the lower end of the central thereby to create two individual impression chambers impression chambers which are so configured as to be accessed from the occlusal surface.

21 A hollow cylindrical custom impression transfer coping comprising:
a central connecting rod upstanding from the roof of the hollow cylindrical custom impression transfer coping, the central connecting rod including at least two upper retention rings defining at least one retention groove therebetween;
a central stop rod depending from the roof of the hollow cylindrical custom impression transfer coping, the central stop rod having a curved lower edge to conform to a healing abutment with which it is adapted to be used;
four radially-extending supporting cross and stop members extending from the vertical stop to the inner cylindrical surfaces of the custom impression transfer coping, thereby to create four injection chambers, each of which are open from the occlusal surface.;
an injection port therein to enable the introduction into the volume within the hollow cylindrical custom impression transfer coping below the roof thereof, of light curable or self curing material; and
a beveled lower circumferential edge of the hollow cylindrical custom impression transfer coping to enable the hollow cylindrical custom impression transfer coping to slide under tissue.

22. The hollow cylindrical custom impression transfer coping as claimed in claim 21, wherein the radially-extending stop members are so configured as to be in contact with the healing abutment and so are configured to conform to the shape and contour of the healing abutment.

23. The hollow cylindrical custom impression transfer coping as claimed in claim 21, wherein the light cured or self-curing material is injectable into each of the individual impression chambers to capture the markings on the healing abutment.

24. The hollow cylindrical custom impression transfer coping as claimed in claim 21, wherein the radially-extending stop members are so configured as to be of a greater height than the lower vertical stop members, so as not to be in direct contact with the healing abutment, and to create a space between the lower vertical stop members and the healing abutment to accommodate the light cured or self-curing material.

25. The hollow cylindrical custom impression transfer coping as claimed in claim 21, having less than three lower vertical stop members, thereby providing one individual impression chamber,

26. The hollow cylindrical custom impression transfer coping as claimed in claim 21, having more than three lower vertical stop members a plurality of individual impression chamber.

27. The hollow cylindrical custom impression transfer coping as claimed in claim 21, having less than two retention rings and thus less than two retention grooves.

28. The hollow cylindrical custom impression transfer coping as claimed in claim 21, having more than two retention rings and thus more than two retention grooves.

29. The hollow cylindrical custom impression transfer coping as claimed in claim 21, having retention holes or protuberances on the retention rings.

30. The hollow cylindrical custom impression transfer coping as claimed in claim 21, having retention holes or protuberances in the areas of the retention grooves.

31. The hollow cylindrical custom impression transfer coping as claimed in claim 21, having dissimilar shapes and sizes of the retention rings, thereby to prevent the rotation and/or improper positioning of the custom impression transfer coping.

32. The hollow cylindrical custom impression transfer coping as claimed in claim 21, having dissimilar shapes and sizes of the retention grooves, thereby to prevent the rotation and/or improper positioning of the custom impression transfer coping.

33. A hollow cylindrical custom impression transfer coping comprising:
a central connecting rod upstanding from the roof of the hollow cylindrical custom impression transfer coping, the central connecting rod including at least two upper retention rings defining at least one retention groove therebetween;
a central stop rod depending from the roof of the hollow cylindrical custom impression transfer coping, the central stop rod having a curved lower edge to conform to a healing abutment with which it is adapted to be used;
four radially-extending supporting cross and stop members extending from the vertical stop to the inner cylindrical surfaces of the custom impression transfer coping, thereby to create four injection chambers, each of which are open from the occlusal surface;
an injection port therein to enable the introduction into the volume within the hollow cylindrical custom impression transfer coping below the roof thereof, for the introduction into the hollow cylinder of light curable or self curing material; and
a beveled lower circumferential edge of the hollow cylindrical custom impression transfer coping to enable the hollow cylindrical custom impression transfer coping to slide under tissue.

34 The hollow cylindrical custom impression transfer coping as claimed in claim 33, wherein the lower surfaces of the four radially-extending supporting cross and stop members are so configured as to be in contact with the healing abutment and to conform to the shape and contour of the healing abutment

35 The hollow cylindrical custom impression transfer coping as claimed in claim 33, wherein the light cured or self-curing material is injectable into each of the injection chambers to capture the markings on the healing abutment.

36. The hollow cylindrical custom impression transfer coping as claimed in claim 33, including retention wings thereon.

37. The hollow cylindrical custom impression transfer coping as claimed in claim 36, including an increase in wall height between the four radially-extending supporting cross and stop members and the retention wings, thereby to create an additional chamber space for increased retention of the light cured or self-curing material.

38. The hollow cylindrical custom impression transfer coping as claimed in claim 33 including one or more horizontal wings attached to the outer cylindrical surface of the custom impression transfer coping, thereby to allow for a lower profile custom impression transfer coping

39. The hollow cylindrical custom impression transfer coping as claimed in claim 33, having retention holes, grooves or protuberances on the outer cylindrical surface of the custom impression transfer coping for additional retention of the custom impression transfer coping with the impression material

40. The hollow cylindrical custom impression transfer coping as claimed in claim 33 wherein the wings attached to the outer cylindrical surface of the custom impression transfer coping are of horizontal spiral or any other variation in shape or orientation which aids in the retention of the custom impression transfer coping with the impression material.

41. The hollow cylindrical custom impression transfer coping as claimed in claim 33, wherein the vertical stop is of a greater height than the four radially-extending supporting cross and stop members so that the lower surfaces of the four radially-extending supporting cross and stop members are not in direct contact with the healing abutment, thereby to create a space between the lower surfaces of the four radially-extending supporting cross and stop members and the healing abutment for increased retention of the light cured or self-curing material.

42. The hollow cylindrical custom impression transfer coping as claimed in claim 33, including less than four supporting cross and stop members, thereby providing one individual impression chamber.

43. The hollow cylindrical custom impression transfer coping as claimed in claim 33, including more than four supporting cross and stop members, thereby providing a plurality of individual impression chamber.

44. The hollow cylindrical custom impression transfer coping as claimed in claim 1, wherein the injection port is located to a shoulder of the hollow cylindrical custom impression transfer coping

44. A hollow cylindrical custom impression transfer coping comprising;
a central connecting rod upstanding from the roof of the hollow cylindrical custom impression transfer coping, the central connecting rod including at least two upper retention rings defining at least one retention groove therebetween;
a central stop rod depending from the roof of the hollow cylindrical custom impression transfer coping, the central stop rod having a curved lower edge to conform to a healing abutment with which it is adapted to be used;
an injection port therein, through to a shoulder of the hollow cylindrical custom impression transfer coping below the roof thereof from which the hollow cylinder depends, to enable the introduction into the volume within the hollow cylindrical custom impression transfer coping of light curable or self curing material; and
a beveled lower circumferential edge of the hollow cylindrical custom impression transfer coping to enable the hollow cylindrical custom impression transfer coping to slide under tissue.

45. The hollow cylindrical custom impression transfer coping as claimed in claim 44, including more than one injection port, to allow for the escape of air from the interior of the custom impression transfer coping as the light cured or self curing material is being injected.

46. The hollow cylindrical custom impression transfer coping as claimed in claim 44, having less than two retention rings, and thus less than two retention grooves.

47. The hollow cylindrical custom impression transfer coping as claimed in claim 44, having more than two retention rings, and thus more than two retention grooves.

48. The hollow cylindrical custom impression transfer coping as claimed in claim 44, having retention holes or protuberances on the retention rings.

50. The hollow cylindrical custom impression transfer coping as claimed in claim 44, having retention holes or protuberances in the areas of the retention grooves

48. The hollow cylindrical custom impression transfer coping as claimed in claim 44, having dissimilar shapes and sizes of the retention rings, thereby to prevent the rotation and/or improper positioning of the custom impression transfer coping.

48. The hollow cylindrical custom impression transfer coping as claimed in claim 44, having dissimilar shapes and sizes of the retention grooves, thereby to prevent the rotation and/or improper positioning of the custom impression transfer coping.

49. A method for the preparation of a dental model which comprises:
placing a custom impression transfer coping on a coded healing abutment intraorally;
injecting a fluid or gel material through an access hole in the rear into an air chamber created by said custom impression transfer coping;
solidifying said material is solidified to a very rigid and hard. form;
taking an impression using dental impression material to capture the soft and hard tissues and the custom impression transfer coping;
placing a duplicate healing abutment and implant replica (analog) unit into the custom impression transfer coping in a correct orientation to be fully seated;
flowing gingival mask material around said healing abutment and implant unit;
pouring the impression in dental stone to produce a replica of the implant and healing abutment intraorally; and
preparing the final prosthesis through conventional laboratory techniques

50. A method for preparing a provisional or temporary restoration which comprises:
placing a rubber dam first over the surgical site and a coded healing abutment;
placing a custom impression transfer coping on said coded healing abutment intraaorally in such a manner that said rubber dam is held in place covering the surgical site and sutures from impression procedures;
injecting a fluid or gel material through an access hole in the rear into an air chamber created by said custom impression transfer coping;
solidifying said material to a very rigid and hard condition;
taking an impression using dental impression material to capture the soft and hard tissues and the custom impression transfer coping;
placing a duplicate healing abutment and implant replica (analog) unit into the custom impression transfer coping in a correct orientation to be fully seated;
flowing gingival mask material around said healing abutment and implant unit; pouring an impression in dental stone to produce a replica of the implant and healing abutment intraorally; and
preparing said provisional (temporary) restoration through conventional laboratory techniques.
